(19) United States
(12) Patent Application Publication
(10) Pub. No.: US 2026/0203036 A1
(43) Pub. Date: Jul. 16, 2026

(54) RESTRICTED BOOT DURING FIRMWARE UPDATE

(71) Applicant: DELL PRODUCTS L.P., Round Rock, TX (US)

(72) Inventors: Yung-Sheng Lin, Taoyuan City (TW); Shun-Tang Hsu, Taipei (TW); Bibby Yeh, New Taipei City (TW)

(21) Appl. No.: 19/020,874

(22) Filed: Jan. 14, 2025

(51) Int. Cl. G06F 8/65; G06F 9/4401

(52) U.S. Cl. CPC G06F 8/65; G06F 9/4418

(57) ABSTRACT

A BIOS may determine that a firmware update is available for a first device, and disable a second device prior to implementing the firmware update to the first device.

### FIELD OF THE DISCLOSURE

This disclosure relates to information handling systems, and more particularly relates to restricting boot during firmware updates in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a basic input/output system configured to determine that a firmware update is available for a first device, and to disable a second device prior to implementing the firmware update to the first device.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates an information handling system according to an embodiment of the present disclosure;

FIG. 2 is a flow chart showing a method for restricting boot during firmware updates in an information handling system according to an embodiment of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

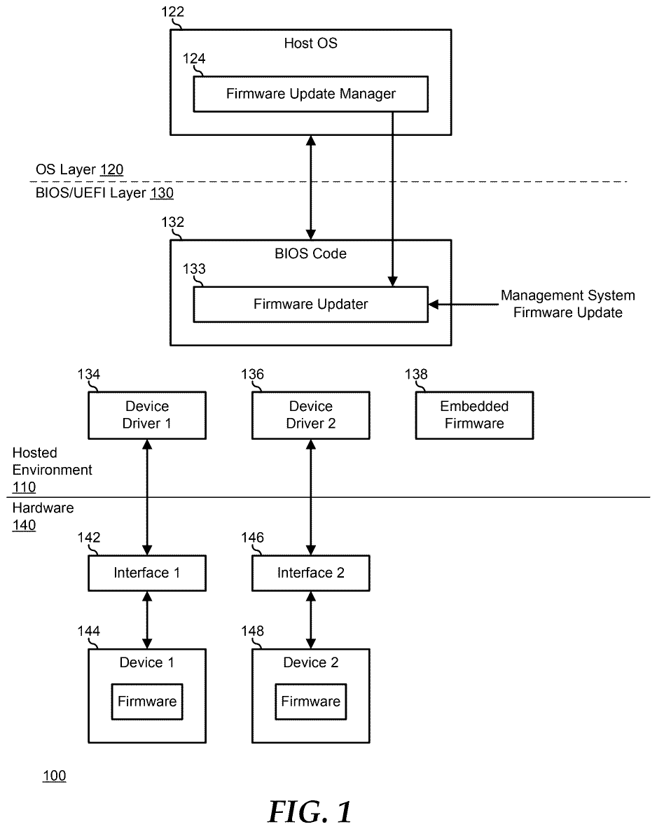

FIG. 1 illustrates an information handling system 100 including a hosted environment 110 and hardware 140. Hosted environment 110 represents a processing environment established on information handling system 100 that is based on a processor (CPU) and the associated hardware devices, and that is commonly associated with the processing tasks that the information handling system performs at the behest of a user. Hardware 140 represents the hardware devices of information handling system 100, such as processors, memory devices, storage devices, network devices, or the like.

Hosted environment 110 includes a host operating system (OS) layer 120 (henceforth referred to as “OS layer 120”) and a basic input/output system (BIOS)/Universal Extensible Firmware Interface (UEFI) layer 130 (henceforth referred to as “BIOS/UEFI 130”). OS layer 120 includes a host OS 122 instantiated on information handling system 100. Host OS 122 includes a firmware update manager 124 as described further below. BIOS/UEFI 130 represents code operable to detect resources within information handling system 100, to provide drivers for the resources, initialize the resources, and access the resources. The functions and features of a BIOS/UEFI are known in the art and will not be further disclosed herein, except as may be needed to illustrate the current embodiments.

BIOS/UEFI 130 includes BIOS code 132, device drivers 134 and 136, and embedded firmware 138. BIOS code 132 includes a firmware updater 133 as described further below. Device drivers 134 and 136 provide interfaces for accessing various the hardware devices as described below. Embedded firmware 138 represents firmware associated with various hardware and software functions and features of information handling system 100. Hardware 140 includes an interface 142 that is connected to an associated device 144, and an interface 146 that is connected to an associated device 148. Devices 144 and 148 each include associated firmware.

The firmware of information handling system 100, including embedded firmware 138 and the firmware for devices 144 and 145, represents code that is typically stored in non-volatile memory devices and that provides low-level instructions to set up the associated device's hardware, to communicate with other devices, and to perform basic tasks. It will be understood that the firmware of information handling system 100 may periodically need to be updated, for example to access newer features of the device, to patch security vulnerabilities in the existing firmware, or the like. The firmware update process is handled by BIOS code 132, and particularly by firmware updater 133. Firmware updater 133 operates to receive an indication that a firmware update is available for a particular device. Such an indication may be provided from firmware update manager 124. For example, host OS 122 may include update features that receive firmware update information from a manufacturer of information handling system 100 or from devices 144 or 148, and my prompt a user of the information handling system to install the associated firmware updates. In another case, the indication that the firmware update is available may be received from a management system connected to information handling system 100.

In either case, when the indication is received that a firmware update is available, firmware updater 133 operates to halt operations on the affected device, or, for system-level firmware, on information handling system 100. Firmware updater 133 then operates to download the firmware update and to store the firmware update to the non-volatile memory location associated with the target device. Firmware updater 133 then reinitializes the device, or, more typically, reboots information handling system 100, at which time the device that received the firmware update will be initialized by the system boot process with the new firmware in place of the original firmware. An example of a firmware update system may include a Firmware Management Protocol (FMP) within a UEFI. It has been understood by the inventors of the current disclosure that the typical firmware update process may introduce security risks, or may result in errors in the update process when multiple firmware updates are performed simultaneously.

In a particular embodiment, firmware updater 133 operates to determine when a firmware update is available, and which device is the target of the firmware update. More particularly, firmware updater 133 determines whether the firmware update is targeted to a device that resides on a particular one of device drivers 134 or 136 or interfaces 142 or 146. If so, firmware updater 133 operates to disable any other device drivers or interfaces that are not associated with the target device. For example, if the firmware update is targeted to the firmware of device 144, then firmware updater 133 operates to disable device driver 136 or interface 146 prior to executing the firmware update of device 144. After completing the firmware update of the target device, firmware updater 133 operates to reinitialize any device drivers or interfaces that were disabled, or, typically to reboot information handling system 100. Then, after the reboot, the target device will operate with the updated firmware.

On the other hand, if the firmware update is not targeted to a device that resides on a particular one of device drivers 134 or 136 or interfaces 142 or 146, then firmware updater 133 operates to disable all device drivers or interfaces that prior to completing the firmware update. For example, if the firmware update is targeted to embedded firmware 138, then firmware updater 133 operates to disable device drivers 134 and 136 or interfaces 142 and 146 prior to executing the firmware update of embedded firmware 138. After completing the firmware update of embedded firmware 138, firmware updater 133 operates to reinitialize device drivers 134 and 136 or interfaces 142 and 144, or, typically to reboot information handling system 100. Then, after the reboot, the embedded firmware 138 will operate with the updated firmware.

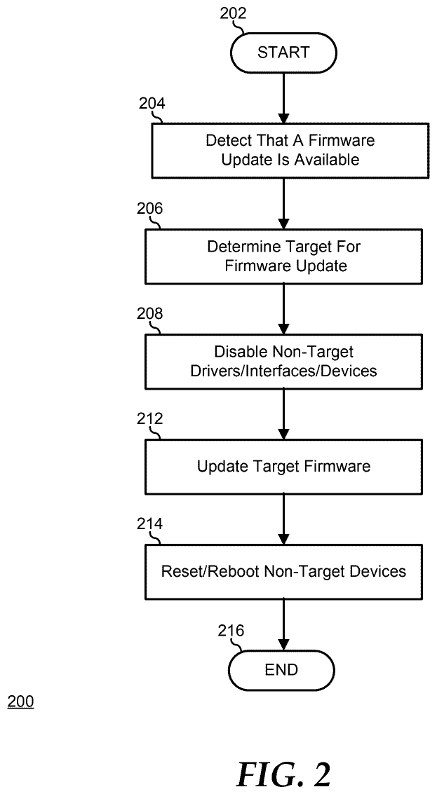

FIG. 2 illustrates a method 200 for restricting boot during firmware updates in an information handling system starting at block 202. A firmware update is detected on an information handling system in block 204, and the target of the firmware update is determined in block 206. Some combination of devices, interfaces, and drivers for the non-target devices for the firmware update are disabled in block 208. The firmware update is provided for the target device in block 212, the non-target devices are reset or rebooted in block 214, and the method ends in block 216.

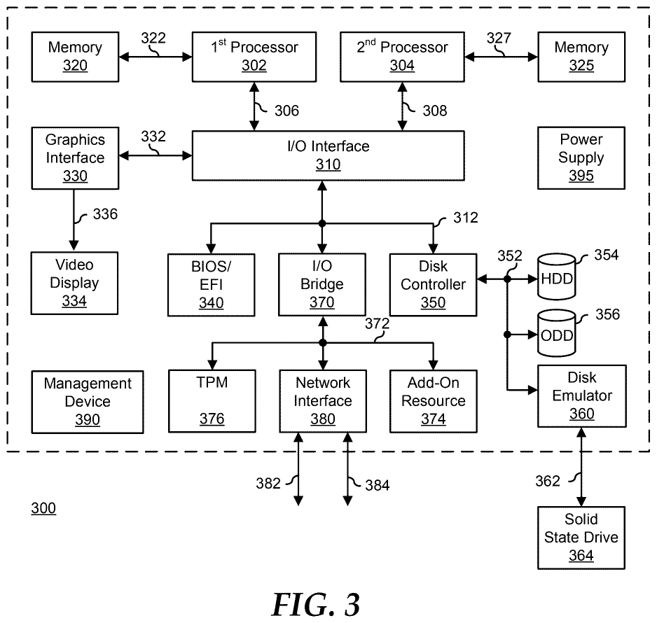

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a basic input/output system (BIOS) instantiated on a processor of the information handling system;
a first device; and
a second device;
wherein the BIOS is configured to determine that a firmware update is available for the first device and to disable the second device prior to implementing the firmware update to the first device.

2. The information handling system of claim 1, further comprising a driver associated with the second device.

3. The information handling system of claim 2 wherein, in disabling the second device, the BIOS is further configured to disable the driver.

4. The information handling system of claim 1, further comprising an interface that couples the second device to the information handling system.

5. The information handling system of claim 4 wherein, in disabling the second device, the BIOS is further configured to disable the interface.

6. The information handling system of claim 1, wherein the BIOS is further configured to implement the firmware update to the first device.

7. The information handling system of claim 6, wherein the BIOS is further configured to reenable the second device after implementing the firmware update to the first device.

8. The information handling system of claim 7 wherein, in reenabling the second device, the BIOS is further configured to reinitialize the second device.

9. The information handling system of claim 7 wherein, in reenabling the second device, the BIOS is further configured to reboot the information handling system.

10. The information handling system of claim 1, wherein the BIOS is further configured to reboot the information handling system after implementing the firmware update to the first device.

11. A method, comprising:
instantiating, on a processor of an information handling system, a basic input/output system (BIOS);
providing, on the information handling system, a first device and a second device;
determining, by the BIOS, that a firmware update is available for the first device; and
disabling, by the BISOS, the second device prior to implementing the firmware update to the first device.

12. The method of claim 11, further comprising providing, on the information handling system, a driver associated with the second device.

13. The method of claim 12 wherein, in disabling the second device, the method further comprises disabling the driver.

14. The method of claim 11, further comprising providing, on the information handling system, an interface that couples the second device to the information handling system.

15. The method of claim 14 wherein, in disabling the second device, the method further comprises disabling the interface.

16. The method of claim 11, further comprising implementing, by the BIOS, the firmware update to the first device.

17. The method of claim 16, further comprising reenabling the second device after implementing the firmware update to the first device.

18. The method of claim 17 wherein, in reenabling the second device, the method further comprises reinitializing the second device.

19. The method of claim 17, wherein, in reenabling the second device, the method further comprises rebooting the information handling system.

20. An information handling system, comprising:
a basic input/output system (BIOS) instantiated on a processor of the information handling system; and
embedded firmware code;
wherein the BIOS is configured to determine that a firmware update is available for the embedded firmware code and to disable a device of the system prior to implementing the firmware update to the embedded firmware code.
